(19) United States
(12) Patent Application Publication
(10) Pub. No.: US 2025/0233960 A1
(43) Pub. Date: Jul. 17, 2025

(54) ELECTRONIC DEVICE AND METHOD FOR ADAPTIVE VIDEO DISPLAY MANAGEMENT BASED ON REGION LOCALIZED REGENERATION OF FRAMES

(71) Applicant: SAMSUNG ELECTRONICS CO., LTD., Suwon-si (KR)

(72) Inventors: Yashwant Singh SAINI, Alwar (IN); Sourav GHOSH, Kolkata (IN); Atikant SINGH, Bangalore (IN); Jayesh Rajkumar VACHHANI, Bangalore (IN); Vibhav AGARWAL, Bengaluru (IN); Sourabh Vasant GOTHE, Belagavi (IN); Barath Raj KANDURRAJA, Bangalore (IN); Parameswaranath Vadackupurath MANI, Alappuzha (IN); Himanshu ARORA, Bangalore (IN); Likhith AMARVAJ, Bangalore (IN); Rishabh KHURANA, Dehradun (IN); Satyam KUMAR, Patna-12 (IN); Pranay KASHYAP, Greater Noida (IN); Karri Hima Satya HEMANTH, Bangalore (IN); Ishaan NEJEEB, Ernakulam (IN)

(73) Assignee: SAMSUNG ELECTRONICS CO., LTD., Suwon-si (KR)

(21) Appl. No.: 18/802,905

(22) Filed: Aug. 13, 2024

Related U.S. Application Data
(63) Continuation of application No. PCT/KR2024/010106, filed on Jul. 15, 2024.

(30) Foreign Application Priority Data
Jan. 12, 2024 (IN) 02441002556

(51) Int. Cl. H04N 7/01; G06T 7/11; G06T 7/246; G06T 7/50; G06T 7/70; G06V 20/40; G10L 25/57

(52) U.S. Cl. CPC H04N 7/0122; G06T 7/11; G06T 7/246; G06T 7/50; G06T 7/70; G06V 20/41; G06V 20/44; G10L 25/57; G06T 2207/10016; G06T 2207/10024; G06T 2207/20164; G06T 2207/30201

(57) ABSTRACT

A method for displaying a video, includes: identifying a primary event in a primary region and one or more secondary events in one or more secondary regions, within each of video frames of a video, based on an analysis of the video frames; recognizing a semantic relationship between the identified primary event and the one or more secondary events; determining a first aspect ratio in which the video is displayed on at least one of an electronic device or one or more applications; predicting, using an AI model, positions of the primary event and the one or more secondary events, based on the semantic relationship and the determined first aspect ratio; and generating frames matching the determined first aspect ratio and having the predicted positions of the primary event and one or more secondary events for displaying the video having the generated frames and the determined first aspect ratio.

### CROSS-REFERENCE TO RELATED APPLICATIONS

This application is a by-pass continuation application of International Application No. PCT/KR2024/010106, filed on Jul. 15, 2024, which is based on and claims priority to Indian Patent Application No. 202441002556, filed on Jan. 12, 2024, in the Indian Intellectual Property Office, the disclosures of which are incorporated by reference herein their entireties.

### BACKGROUND

### 1. Field

The disclosure generally relates to adaptive video display management. In particular, the disclosure relates to methods and electronic devices for adaptive video display management based on region localized regeneration of frames.

### 2. Description of Related Art

A feature of sharing videos that are edited to capture essential events or to portray the subject interactively has been revolutionized. Through powerful digital tools and platforms, individuals can create, modify, and distribute video content in their network. This dynamic process enables the individuals to convey stories, share knowledge, and connect with viewers on a deeper level. The advantages of video sharing and editing include an ability to craft fascinating narratives, and tailor content.

Currently, there are various techniques available for video editing. However, the related techniques present challenges in adapting content for optimal viewing experiences across multiple devices, particularly for sharing shorts or reels via social networking platforms.

FIG. 1 illustrates a related technique of generating a video wallpaper according to a state-of-the-art solution. The video wallpaper is an immersive wallpaper for electronic devices such as smartphones, computers, and other digital screens. Unlike static images, video wallpapers consist of moving visual content, which includes subtle animations, interactive scenes and the like. The video wallpaper generation typically involves the creation or selection of video content, which is then optimized and formatted to serve as a wallpaper. The video content may be tailored to loop seamlessly, ensuring a continuous and seamless visual experience. Presently, video content creators and editors manually adjust the aspect ratio of the videos to suit different platforms and devices. This leads to inconsistent viewing experiences and potential distortion of the video content to the end user.

Moreover, when considering various electronic devices such as foldable phones, flip phones, standard smartphones, laptops, and televisions (TVs), it's important to note that these electronic devices have a wide range of aspect ratios, resolutions, file format compatibility. However, having a diverse range of aspect ratio poses various challenges for the video viewing experience. For example, when video content is not optimized for each specific aspect ratio, it may lead to content being cropped, distorted, or not fully utilizing the available screen space. This can result in inconsistent viewing experiences and potential loss of important context or visual quality, affecting user satisfaction. Accordingly, the video editing requires consideration of device-specific requirements, such as the resolution, the aspect ratio, and the file format compatibility, to ensure optimal performance and visual appeal.

In the related art, the device-specific requirements have to be manually fed. Further, the device-specific requirements may not be accurately fed thereby making the mismatch of specification when displayed across various electronic devices having different configurations. Further, in some cases, the video content is centre crop, for example as shown in block 101 of FIG. 1 for the generation of the video wallpaper. Thus, in a case that the user, as shown in block 103 of FIG. 1, wants to edit the video content to make herself prominent in the video content, then the related techniques fails to do so. Accordingly, the related techniques lacks personalization of the context with respect to its preferences, different device-specific requirements, and activities leading to a lack of tailored video content presentation.

### SUMMARY

According to an aspect of the disclosure, an aspect ratio based method for displaying a video, may include identifying a primary event in a primary region and one or more secondary events in one or more secondary regions, within each of video frames of a video, based on an analysis of the video frames. According to an aspect of the disclosure, an aspect ratio based method for displaying a video, may include obtaining a semantic relationship between the identified primary event and the one or more secondary events. According to an aspect of the disclosure, an aspect ratio based method for displaying a video, may include determining a first aspect ratio in which the video is displayed on at least one of an electronic device or one or more applications. According to an aspect of the disclosure, an aspect ratio based method for displaying a video, may include predicting, using an Artificial Intelligence (AI) model, positions of the primary event and the one or more secondary events, based on the semantic relationship and the determined first aspect ratio. According to an aspect of the disclosure, an aspect ratio based method for displaying a video, may include obtaining frames matching the determined first aspect ratio and having the predicted positions of the primary event and one or more secondary events. According to an aspect of the disclosure, an aspect ratio based method for displaying a video, may include displaying the video having the obtained frames and the determined first aspect ratio.

According to an aspect of the disclosure, an aspect ratio based an electronic device for displaying a video, the electronic device may include one or more processors. According to an aspect of the disclosure, the one or more processors may be configured to identify a primary event in a primary region and one or more secondary events in one or more secondary regions within each video frames of a video based on an analysis of the video frames. According to an aspect of the disclosure, the one or more processors may be configured to obtain a semantic relationship between the identified primary event and the one or more secondary events. According to an aspect of the disclosure, the one or more processors may be configured to determine a first aspect ratio in which the video is to be displayed on at least one of an electronic device or one or more applications. According to an aspect of the disclosure, the one or more processors may be configured to predict, using an Artificial Intelligence (AI) model, positions of the primary event and the one or more secondary events according to the semantic relationship and the determined first aspect ratio. According to an aspect of the disclosure, the one or more processors may be configured to obtain frames matching the determined first aspect ratio and having the predicted positions of the primary event and one or more secondary events. According to an aspect of the disclosure, the one or more processors may be configured to display the video with the obtained frames with the determined first aspect ratio.

One embodiment provides a machine readable medium containing instructions. The instructions, when executed by at least one processor, may cause the at least one processor to perform the method corresponding.

### BRIEF DESCRIPTION OF THE DRAWINGS

To further clarify the advantages and features of the disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

These and other features, aspects, and advantages of the disclosure will become better understood when the following detailed description is read with reference to the accompanying drawings in which like characters represent like parts throughout the drawings, wherein:

FIG. 1 illustrates a related technique of generating video wallpaper according to a state-of-the-art solution;

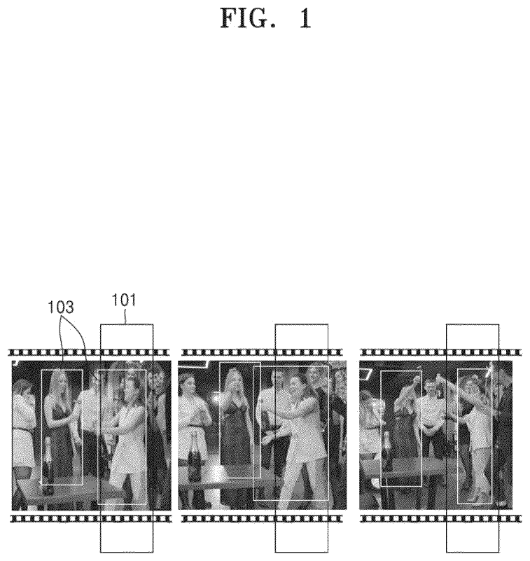

FIG. 2 illustrates an exemplary general architecture of the aspect ratio based adaptive video display management of the electronic device according to an embodiment of the disclosure;

FIG. 3 illustrates various components of FIG. 2, according to an embodiment of the disclosure;

FIG. 4 illustrates a flow chart for the aspect ratio based method for displaying a video, according to an embodiment of the disclosure;

FIG. 5 illustrates an example video frame having a primary region and one or more secondary regions, according to an embodiment of the disclosure;

FIG. 6 illustrates a flow chart for the depth-aware optical flow estimation, according to an embodiment of the disclosure;

FIG. 7 illustrates a flow chart for the spatiotemporal convex hull construction, according to an embodiment of the disclosure;

FIG. 8 illustrates an operation for analyzing the audio and the multi-modal contextual inputs by the extractor, according to an embodiment of the disclosure;

FIG. 9 illustrates a method flow prioritizing the primary event and the secondary events, according to an embodiment of the disclosure;

FIG. 10 illustrates a method for recognizing the semantic relationship between the primary event and the one or more secondary events, according to an embodiment of the disclosure;

FIG. 11 illustrates a detailed operation generation of frames with a target aspect ratio, according to an embodiment of the disclosure;

FIG. 12 illustrates an event-positioned frame generation (G1) 1107, according to an embodiment of the disclosure;

FIG. 13 illustrates a refined frame generation (G2) according to an embodiment of the disclosure;

FIG. 14 illustrates a background synthesis block according to an embodiment of the disclosure;

FIG. 15 illustrates an example of the generated frames, according to an embodiment of the disclosure;

FIG. 16 illustrates an example of the generated frames in comparison to a conventional method, according to an embodiment of the disclosure, and

FIG. 17 illustrates an example of the generated frames, according to an embodiment of the disclosure.

Further, skilled artisans will appreciate that elements in the drawings are illustrated for simplicity and may not have been necessarily been drawn to scale. For example, the flow charts illustrate the method in terms of the most prominent operations involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### DETAILED DESCRIPTION

It should be understood at the outset that although illustrative implementations of the embodiments of the disclosure are illustrated below, the disclosure may be implemented using any number of techniques, whether currently known or in existence. The disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments, to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching, and illuminating some embodiments and their specific features and elements and does not limit, restrict, or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element does NOT preclude there being none of that feature or element, unless otherwise specified by limiting language such as “there NEEDS to be one or more . . . ” or “one or more element is REQUIRED.”

The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

Unless otherwise defined, all terms, and especially any technical and/or scientific terms, used herein may be taken to have the same meaning as commonly understood by one having ordinary skill in the art.

Embodiments of the disclosure will be described below in detail with reference to the accompanying drawings.

According to an embodiment, the disclosure discloses an aspect ratio based adaptive video display management of the electronic device. According to an embodiment, the aspect ratio based adaptive video display management of the electronic device generate frames with respect to an aspect ratio in which the video is to be displayed on at least one of the device or the one or more applications. In an embodiment, the aspect ratio based adaptive video display management of the electronic device identifies one or more localized events within each video frame of a video and determines a semantic relationship between the one or more localized events by performing video analysis on video frames, analysis on multi-modal contextual inputs that are received from a user. The aspect ratio based adaptive video display management of the electronic device further predicts positions of the one or more localized events within each video frame according to the semantic relationship and the aspect ratio. The aspect ratio based adaptive video display management of the electronic device further generates the frames matching the aspect ratio in which the video is to be displayed. Further, the generated frames have the one or more localized events positioned based on the predicted position.

A detailed methodology is explained in the following paragraphs of the disclosure.

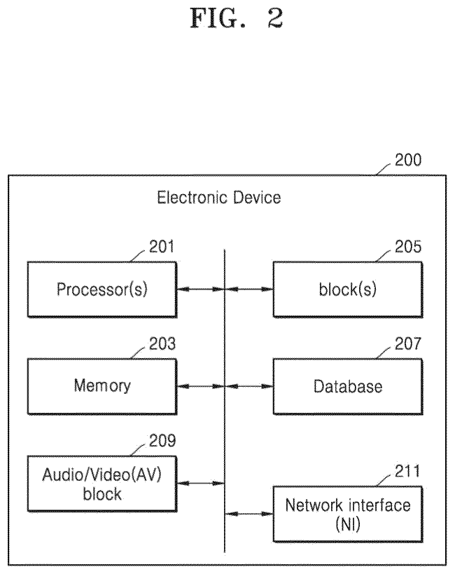

FIG. 2 illustrates an exemplary general architecture of the aspect ratio based adaptive video display management of the electronic device according to an embodiment of the disclosure. FIG. 2 describes the aspect ratio based adaptive video display management of the electronic device 200. In an example, the aspect ratio based adaptive video display management of the electronic device 200 includes electronic devices such as a personal computer (PC), a smartphone, a laptop, a desktop computer, or any computing system capable of processing and displaying video content. The aspect ratio based adaptive video display management of the electronic device 200 includes a processor(s) 201, a memory 203, a block(s) 205, a database 207, an Audio/Video (AV) block 209, and a network interface (NI) 211 coupled with each other. The aspect ratio based adaptive video display management of the electronic device 200 may be alternately referred to as aspect ratio based the electronic device 200 or the electronic device 200 throughout the disclosure.

The block(s) 205 may be implemented by a program that is stored in a storage medium (e.g., the memory 203) which may be addressed, and is executed by a processor (e.g., the processor(s) 202). For example, the block(s) 205 may be implemented by components such as software components, object-oriented software components, class components, and task components, processes, functions, attributes, procedures, sub-routines, segments of a program code, drivers, firmware, a micro code, a circuit, data, a database, data structures, tables, arrays and parameters. Also, the block(s) 205 may refer to a hardware component such as a processor (e.g., the processor(s) 202) or a circuit, and/or a software component executed by a hardware component such as a processor (e.g., the processor(s) 202).

In an example, the processor(s) 201 may be a single processing unit or a number of units, all of which could include multiple computing units. The processor(s) 201 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor(s) 201 is configured to fetch and execute computer-readable instructions and data stored in the memory 203.

The memory 203 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

As an example, the block(s) 205 may include a program, a subroutine, a portion of a program, a software component, or a hardware component capable of performing a stated task or function. As used herein, the block(s) 205 may be implemented on a hardware component such as a server independently of other blocks, or a block can exist with other blocks on the same server, or within the same program. The block(s) 205 may be implemented on a hardware component such as processor one or more microprocessors, microcomputers, microcontrollers, digital signal processors, central processing units, state machines, logic circuitries, and/or any devices that manipulate signals based on operational instructions. The block(s) 205 when executed by the processor(s) 201 may be configured to perform any of the described functionalities.

As an example, the database 207 may be implemented with integrated hardware and software. The hardware may include a hardware disk controller with programmable search capabilities or a software system running on general-purpose hardware. The examples of the database 207 are, but are not limited to, in-memory databases, cloud databases, distributed databases, embedded databases, and the like. The database 207, amongst other things, serves as a repository for storing data processed, received, and generated by one or more of the processors.

In an embodiment, the block(s) 205 may be implemented using one or more AI models that may include a plurality of neural network layers. Examples of neural networks include but are not limited to, Convolutional Neural Network (CNN), Deep Neural Network (DNN), Recurrent Neural Network (RNN), Restricted Boltzmann Machine (RBM). According to an embodiment, the block(s) 205 may be implemented using one or more generative AI models that may include Variational Autoencoders (VAEs), Generative Adversarial Networks (GANs), flow-based generative model, auto-regressive models and the like. Further, ‘learning’ may be referred to in the disclosure as a method for training a predetermined target device (for example, a robot) using a plurality of learning data to cause, allow, or control the target device to make a determination or prediction. Examples of learning techniques include but are not limited to supervised learning, unsupervised learning, semi-supervised learning, or reinforcement learning. At least one of a plurality of CNN, DNN, RNN, RMB, VAES, GANs, flow-based generative model, auto-regressive models and the like may be implemented to thereby achieve execution of the present subject matter's mechanism through an AI model or generative AI models. A function associated with an AI model or the generative AI models may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). One or a plurality of processors or neural processors control the processing of the input data in accordance with a predefined operating rule or artificial intelligence (AI) model or generative AI models stored in the non-volatile memory and the volatile memory. The predefined operating rule or artificial intelligence model is provided through training or learning.

As an example, the AV block 209 may obtain audio data and video data from the memory 203 of the electronic device 200 or any electronic device. As an example, the NI unit 211 may establish a network connection with a network like a home network, a public network, or a private network and the like to obtain the video content.

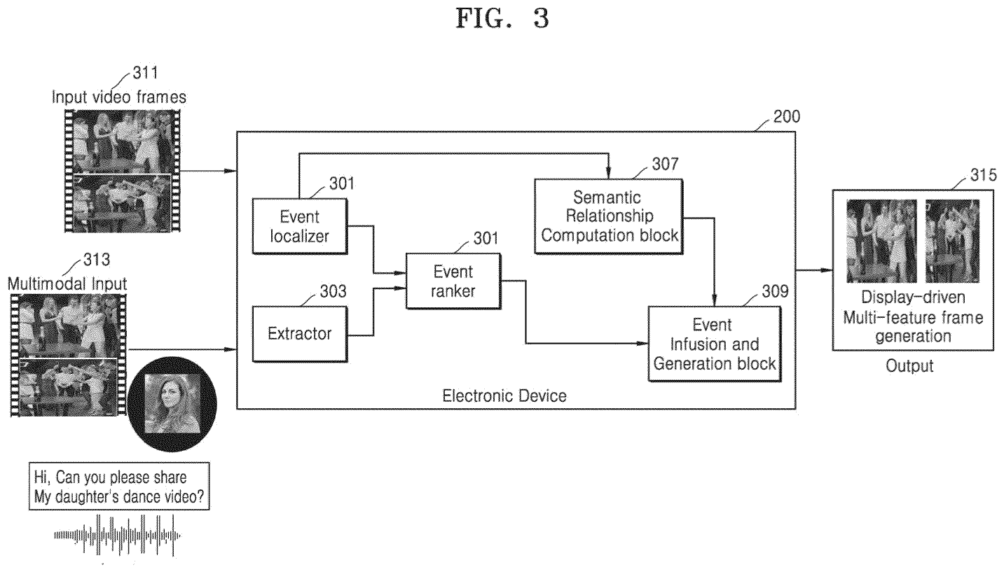

FIG. 3 illustrates various components of FIG. 2, according to an embodiment of the disclosure. As shown in FIG. 3, the block(s) 205 of the electronic device 200 may include an event localizer 301, an extractor 303, an event ranker 305, a semantic relationship computation block 307, an event infusion and generation block 309 coupled with each other.

The event localizer 301, the extractor 303, the event ranker 305, the semantic relationship computation block 307, the event infusion and generation block 309 may be implemented by a program that is stored in a storage medium (e.g., the memory 203) which may be addressed, and is executed by a processor (e.g., the processor(s) 203). For example, the event localizer 301, the extractor 303, the event ranker 305, the semantic relationship computation block 307, the event infusion and generation block 309 may be implemented by components such as software components, object-oriented software components, class components, and task components, processes, functions, attributes, procedures, sub-routines, segments of a program code, drivers, firmware, a micro code, a circuit, data, a database, data structures, tables, arrays and parameters. Also, the event localizer 301, the extractor 303, the event ranker 305, the semantic relationship computation block 307, the event infusion and generation block 309 may refer to a hardware component such as a processor (e.g., the processor(s) 203) or a circuit, and/or a software component executed by a hardware component such as a processor (e.g., the processor(s) 203).

In an embodiment, as shown in FIG. 3, the electronic device 200 may obtain video frames 311, and multi-modal contextual inputs 313 from at least one of a user input or one or more applications installed in the electronic device 200 or electronic device. As an example, the multi-modal contextual inputs may include at least one of incoming messages, profile pictures of one or more users, future frames in the video frames 311, or an activity associated with the one or more users. As an example, the future frames in the video frames 311 may be the upcoming frames in the video frames 311. In an embodiment, various above-mentioned components of the block(s) 205 may analyze the video frames 311, and the multi-modal contextual inputs 313 and generate frames as an output 315. In an embodiment, the output 315 may be regenerated frames based on a display-driven multi-feature generation technique for display that incorporates multiple features or attributes. The regenerated frame 315 may take into account the display's specific attributes, and the multi-modal contextual inputs, and optimizes frame generation to align with these characteristics. The regenerated frame 315 encompasses factors such as resolution, aspect ratio, other display-specific features, and the like. Further, the video frames may be alternately referred to as frames throughout the disclosure. The detailed working of each of the components of FIG. 2 will be explained in the forthcoming paragraphs through FIGS. 2-14.

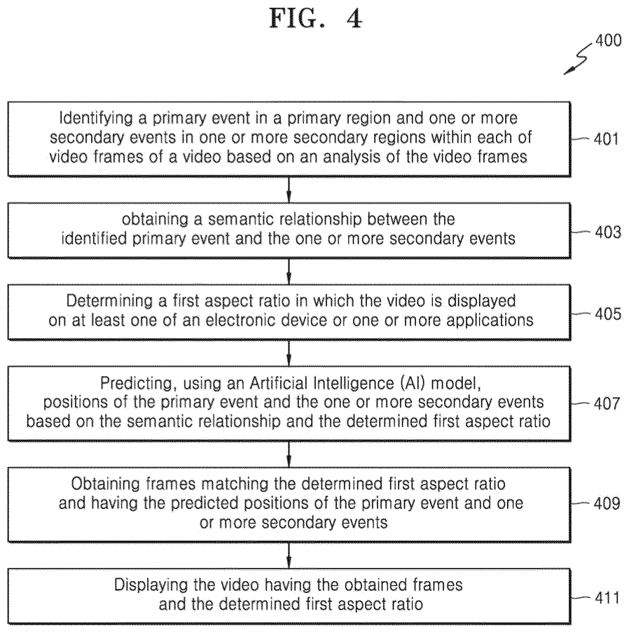

FIG. 4 illustrates a flow chart for the aspect ratio based method 400 for displaying a video, according to an embodiment of the disclosure. According to an embodiment, the method 400 is implemented the electronic device 200 of FIG. 2. Further, the method 400 is implemented through the operations 401 to 409 performed by various components of the block(s) 205. According to an embodiment, the functions of the block(s) 205 may be alternately performed by the processor(s) 201. However, for ease of understanding the operations 401 to 409 will be explained by referring through various block(s) 205. Further, the reference numerals were kept the same for the similar components for ease of understanding.

According to an embodiment, initially, the event localizer 301 may obtain the video frames 311 as input from at least one of the user input or the one or more application that is installed in the electronic device 200. According to an embodiment, the event localizer 301 may identify a primary event in a primary region and one or more secondary event in one or more secondary regions within each video frame of the video based on an analysis of the video frames 311. In an embodiment, the event localizer 301 may identify, at operation 401 the primary region and the one or more secondary regions within each video frame by performing an analysis of video frames 311. Operation 401 i.e., the method for identification of the primary event in the primary region and the one or more secondary event in the one or more secondary regions will be explained in the forthcoming paragraphs.

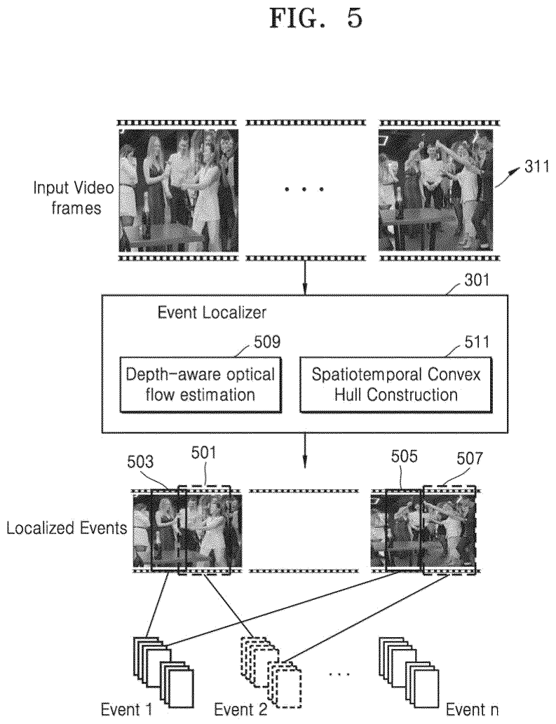

FIG. 5 illustrates an example video frame having a primary region and one or more secondary regions, according to an embodiment of the disclosure. As can be seen from FIG. 5, the regions 501 and 507 are the primary regions as the actual event in the given scenario is a cake-cutting event. Further, the regions 503 and 505 are the secondary regions as the regions are neighboring to the primary region or the actual event (i.e. the cake-cutting event).

In an embodiment, the event localizer 301 may perform depth-aware optical flow estimation 509 and spatiotemporal convex hull construction method 511 for identifying the primary region and the one or more secondary regions. For example, the primary region may correspond to a region in the video frame where the actual event is occurring, and the one or more secondary regions are the regions neighboring to the primary region or the actual event.

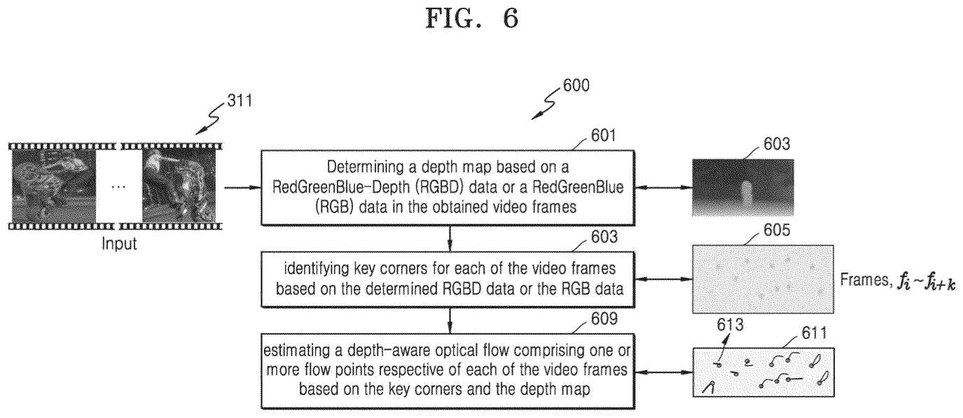

FIG. 6 illustrates a flow chart for the depth-aware optical flow estimation, according to an embodiment of the disclosure. The method 600 illustrates the depth-aware optical flow estimation that is implemented in the event localizer 301. In an embodiment, for the depth-aware optical flow estimation, the eventlocalizer 301, initially at operation 601, may take the video frame as the input. According to an embodiment, by using related techniques, RedGreenBlue-Depth (RGBD) data or RedGreenBlue (RGB) data is obtained from the obtained video frames 311. Accordingly, the event localizer 301 may determine a depth map 603 based on the RGBD data or the RGB data. In an example, if RGBD data is available then the depth map is extracted from the D channel. Otherwise, the depth map is obtained by applying depth estimation on the RGB data.

According to an embodiment, at operation 605, the event localizer 301 may identify key corners for each of the video frames 311 based on the determined RGBD data or the RGB data. In an embodiment, the event localizer 301 may determine key features 607 in frames (fᵢ˜fᵢ₊ₖ). Further, the key corners for each key feature in each video frame are determined.

According to an embodiment, at operation 609, the event localizer 301 may estimate a depth-aware optical flow 611. The depth-aware optical flow 611 may include one or more flow points 613 respective of each of the video frames 311 based on the key corners and the depth map. In an example, the depth-aware optical flow 611 of each of the video frames 311 may include motion vectors and flow between the video frames 311. Further, the depth-aware optical flow 611 may include one or more flow points respective of each of the video frames 311. Furthermore, the depth-aware optical flow 611 between the video frames 311 may represent a movement of one or more flow points along with the video frames 311. The operation 601, 605, and 609 describe the depth-aware optical flow estimation 509.

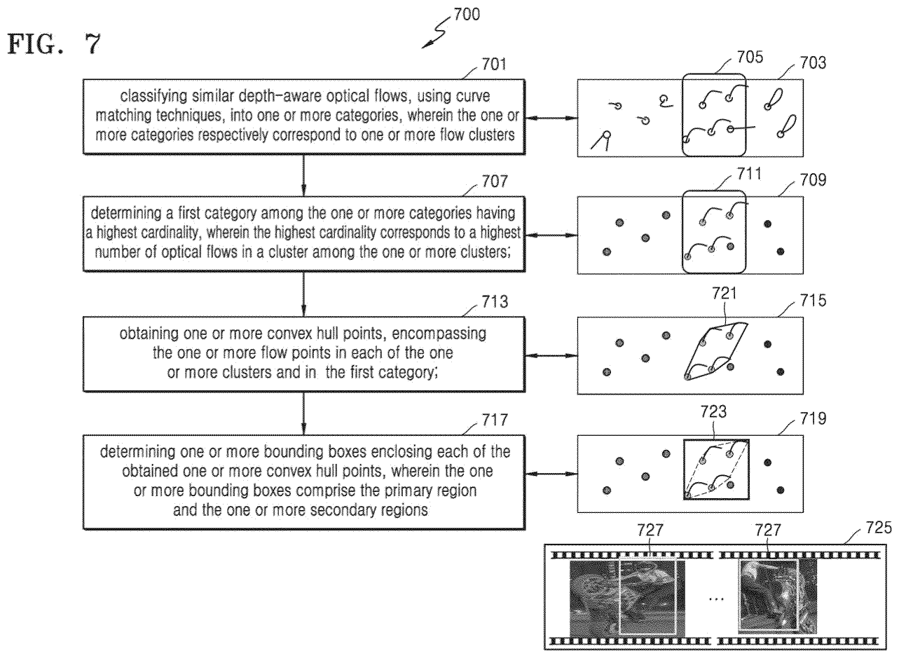

FIG. 7 illustrates a flow chart for the spatiotemporal convex hull construction, according to an embodiment of the disclosure. The method 700 illustrates the spatiotemporal convex hull construction method 511 that is implemented in the event localizer 301. According to an embodiment, at operation 701, the event localizer 301 may classify similar depth-aware optical flows, using curve matching techniques, into one or more categories. In an embodiment, the one or more categories may correspond to one or more flow clusters. As can be seen in block 703, patterns of the depth-aware optical flow points are identified. Based on the flow patterns of the depth-aware optical flow, similar depth-aware optical flows are identified. The similar depth-aware optical flows are then classified into one or more categories. For example, in block 705 the depth-aware optical flow points may be similar and hence be classified in a single category.

According to an embodiment, at operation 707, the event localizer 301, may determine a first category among the one or more categories that has a highest cardinality. In an embodiment, depth-aware optical flow that has the highest number of optical flow points may be determined to be in the first category. For example, in block 711, the first category may include the cluster that has the highest cardinality.

According to an embodiment, at operation 713, the event localizer 301 may obtain one or more convex hull points, encompassing the one or more flow points in each of the one or more clusters and the first category. For example, in block 715, the convex hull point may be constructed that encompasses each of the clusters along with the first category. For example, in block 715, the convex hull points 721 may encompass the cluster of the first category. Further, the convex hull around flow points may prevent a jittery crop region that fluctuates rapidly with frame. Further, at operation 717, the event localizer 301 may determine one or more bounding boxes enclosing each of the obtained one or more convex hull points. For example, in block 719, the bounding box 723 may enclose the convex hull points 721. The output of the depth-aware optical flow estimation 509 and spatiotemporal convex hull construction method 511 process are shown in block 725. As can be seen, the bounding box, in the given example scenario, may include the primary region 727. Further, in the same manner, the one or more secondary regions in the frame can be identified. For example, and referring back to FIG. 5, the one or more bounding boxes may indicate identified localized events (e.g. Event 1, Event 2, . . . . Event n) in the primary regions 501, 507 of each frame and in the one or more secondary regions 503, 505 of each frame. In an embodiment of FIG. 5 only one secondary region is shown in each frame for the sake of brevity, however, there can be more than one secondary region in each frame.

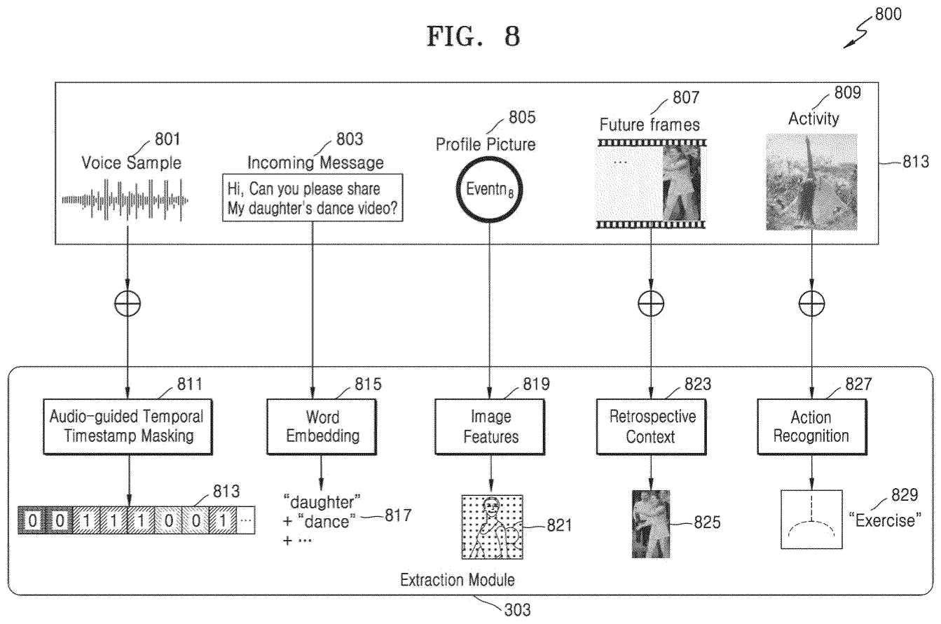

FIG. 8 illustrates an operation for analyzing the audio and the multi-modal contextual inputs by the extractor 303, according to an embodiment of the disclosure. According to an embodiment, the extractor 303 may receive the multi-modal contextual inputs 313 for example, but are not limited to, voice samples 801 associated with the audio in each frames, the incoming messages 803 received by the one or more applications, the profile picture 805 obtained from the one or more applications, future frames 807 of the received video and the activity 809 associated with the user that is obtained from the one or more applications. According to an embodiment, the extractor 303 may perform an analysis of the audio and the multi-modal contextual inputs. In an embodiment, for performing the analysis of the audio and the multi-modal contextual inputs, the extractor 303 may obtain a plurality of features from the multi-modal contextual input and audio features of the audio of the video frames 311.

In an embodiment, from the voice samples 801, personalization of the voice may be performed by using audio-guided temporal timestamp masking technique 811. The audio-guided temporal timestamp masking technique focuses on relevant audio segments for understanding speech of the users in the primary region and the one or more secondary regions. The personalization of the voice thereby leads to determine a context in the localized events. In an embodiment, the voice samples 801 when processed by the audio-guided temporal timestamp masking technique 811 may generate an output 813. The output 813 includes a masked temporal timestamped audio data where the less relevant segment are masked. In an embodiment, the output 813 may be provided to recurrent neural network (RNN) models. The RNN models process and provide a k-dimensional output which is further trained via backpropagation based on a contextual contrastive loss function which is predefined. The k-dimensional output represents a contextual features of the voice samples 801.

In an embodiment, the incoming messages 803 may be analyzed to determine the word embeddings by performing word tokenization. For example, the incoming message 803 may be “Hi, can you please share my daughter's dance video”. Therefore, after performing word tokenization, the word embeddings like “daughter” and “dance” can be obtained. The determining of the word embeddings provides a text based personalization. The words embeddings 817 are then inputted to a Bidirectional Long Short-Term Memory (Bi-LSTM) model. The Bi-LSTM model processes the words embeddings 817 and provide the k-dimensional output which is further trained via backpropagation based on the contextual contrastive loss function which is predefined. The k-dimensional output represents a contextual features of the incoming messages 803.

In an embodiment, the profile picture 805 of one or more users may be analyzed to determine feature map or image features 819 of the profile picture using deep convolution network. In an embodiment, batch normalization may be performed on the feature map or the image features 819 to obtain the k-dimensional output. The k-dimensional output is further trained via backpropagation based on the contextual contrastive loss function which is predefined. The k-dimensional output represents a contextual features of the profile picture 805. In an embodiment, an output 821 may be the representation of the feature map for the given input profile picture 805 which are obtained after applying the deep convolution network.

In an embodiment, the future frames 807 and the activities 809 of the user may be analyzed to obtain a retrospective context 823 and action recognition 827 in each of the frames. For example, analyzing the future frames may provide the context of the current frames as depicted in block 825. Further, analyzing the activity may provide the context of the activity perform by the user in the current frame for example “dance” as depicted in the block 829. The extractor 303 performs spatial-cognitive event planning for analyzing the future frames and the activities of the user. In an embodiment, the output of the retrospective context 823 and action recognition 827 may be provided to the event encoder to output the k-dimensional output. The k-dimensional output is further trained via backpropagation based on the contextual contrastive loss function which is predefined. The k-dimensional output represents the contextual features of the future frames 807 and activities 809.

In an embodiment, the primary event in the primary region and the one or more secondary events in the one or more secondary regions may be identified based on determined contextual features. According to an embodiment, the primary event and the one or more secondary events may be ranked and prioritized. The forthcoming paragraphs describe the operation of ranking and prioritization of the primary event and the one or more secondary events.

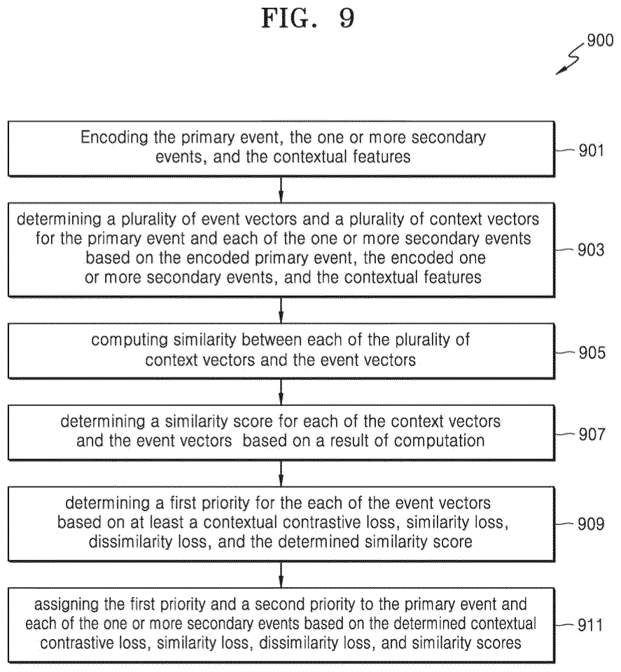

FIG. 9 illustrates a method flow prioritizing the primary event and the secondary events, according to an embodiment of the disclosure. According to an embodiment, the event ranker 305 may perform a method 900 prioritizing the primary event and the secondary events. According to an embodiment, the event ranker 305 may take the contextual features that were determined by the extractor 303, the primary events, and the one or more secondary events as the inputs. In an embodiment, at operation 901, the event ranker 305 may encode the primary event, the one or more secondary events, and the contextual features. According to an embodiment, the event ranker 305 may be implemented with a modality-agnostic fusion encoder. The modality-agnostic fusion encoder combines and encodes the primary event, the one or more secondary events, and the contextual features into a unified representation that effectively captures and represent the relationships and interactions between different modalities of information from each inputs. Further, at operation 903, the event ranker 305 may determine a plurality of event vectors and the plurality of context vectors for the primary event and each of the one or more secondary events, based on the encoded primary event, the encoded one or more secondary events and the encoded contextual features. Furthermore, at operation 905, the event ranker 305 may compute the similarity between each of the plurality of context vectors and event vectors.

The event ranker 305, at operation 907, may determine a similarity score for each of the context vectors and event vectors based on the computation. In an example, at first, the localized events and the contextual features are encoded in the same feature space. Then event priority is determined based on aggregated features using contextual contrastive loss. For each event, the similarity is computed with the context vector in the feature space. The obtained similarity score is leveraged for ranking of events. In an example, Euclidean distance method may be used in the contextual contrastive loss to compute the similarity and dis-similarity between events vectors and context vectors. For example, the context vectors and the event vectors having similar events may be provided the similarity scores based on a level of similarity between each of the context vectors and each of the event vectors. An example of the scores are shown in Table 1 and Table 2 below. In an embodiment, the Table 1 and Table 2 may represent the ground truth. The contextual contrastive loss encourages the embedding to be close to each other for the samples of the same label and the embedding to be far apart at least by the margin constant for the samples of different labels. The same can be envisaged from the truth table.

TABLE 1
of Video sample V1

| | E₁ | E₂ | E₃ | . . . | E_{N} |
|---|---|---|---|---|---|
| Word contextual | 0.29 | 0.85 | 0.67 | . . . | 0.32 |
| vector (C_{1(W))} | | | | | |

TABLE 2
of Video sample Vm

| | E₁ | E₂ | E₃ | . . . | E_{N} |
|---|---|---|---|---|---|
| Word and Image | 0.93 | 0.11 | 0.56 | . . . | 0.21 |
| contextual vector | | | | | |
| (C_{M} (W + I)) | | | | | |

Further, at operation 909, the event ranker 305 may determine a priority for the each of the event vectors based on at least a contextual contrastive loss between truth label and set of localized events, similarity loss, dissimilarity loss, and the determined similarity score. According to an embodiment, the contextual contrastive loss is given by equation (1), the similarity loss between the context vector and matched localized event vector is given by equation (2), and the dissimilarity loss between the context vector and unmatched localized event vector is given by equation (3).

$${L}_{C C} ( Y , {E}_{sim} , 〈 {E}_{{dsim}_{1 … {n}_{e}}} 〉 ) = Y \times {L}_{s i m} + ( 1 - Y ) \times {\sum }_{i = 1}^{{n}_{e}} {L}_{{dsim}_{i}} \qquad ( 1 )$$

$${L}_{s i m} ( C , {E}_{dsim} ) = {D}_{C {E}_{dsim}} \qquad ( 2 )$$

$${L}_{{dsim}_{i}} ( C , {E}_{{dsim}_{i}} ) = max ( 0 , m - {D}_{C {E}_{{dsim}_{i}}} )$$

Where,

D_{xY}=∥X−Y∥₂→L2-norm between 2 embedding's (3)

Here, L_{cc}=Contextual Contrastive Loss;
L_{Sim}=Similar vector pair loss between context vector and matched event;
L_{Dsim}=Dissimilar vector pair loss between context vector and unmatched event;
D_{CESim}=Euclidean distance between Context vector and matched event;
D_{CEdSIM}=Euclidean distance between context vector and unmatched event;
Y=Truth Label; and
m=Hyper parameter margin for segregating similar and non-similar pairs.

Further, at operation 911, the event ranker 305 may assign the first and a second priority to the primary event and each of the one or more secondary events based on the determined contextual contrastive loss, similarity loss, dissimilarity loss, and similarity scores. In an example, each of the primary events and the one or more secondary events may be assigned with priorities.

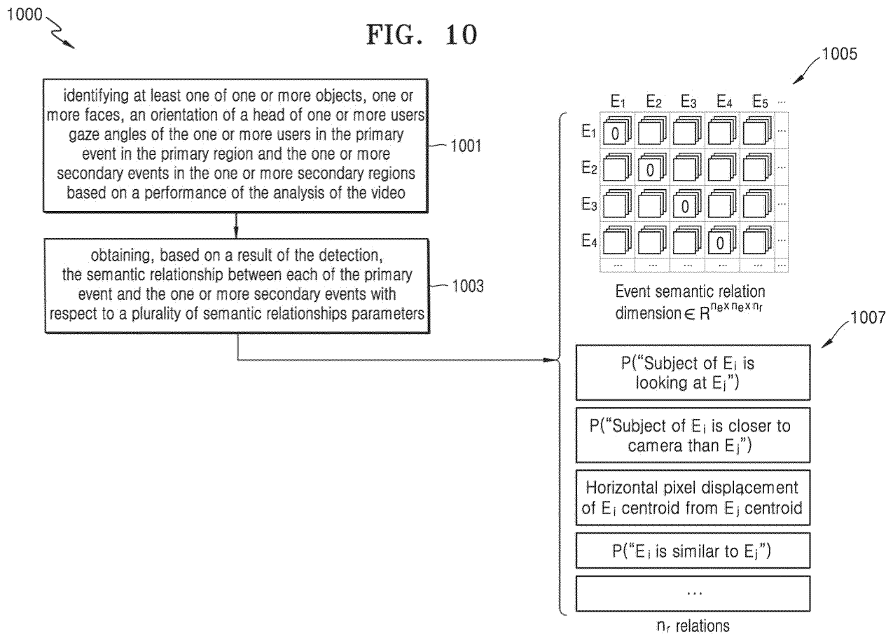

Referring back to FIG. 4, at operation 403, the semantic relationship computation block 307 may obtain a semantic relationship between the identified primary event and the one or more secondary events. FIG. 10 illustrates a method for obtaining the semantic relationship between the primary event and the one or more secondary events, according to an embodiment of the disclosure. In an embodiment, the semantic relationship computation block 307 may take localized events i.e. the primary events and the one or more secondary events determined by the event localizer 301 as input.

Accordingly, at operation 1001, the semantic relationship computation block 307, may identify at least one of one or more objects, one or more faces, orientation of the head of one or more users, gaze angles of the one or more users in the primary event and the one or more secondary events by performing analysis of the video. In an example, the semantic relationship computation block 307 may detect proximity to a camera that captures and send the video, a gaze of the subject in the event (primary event and the secondary event), pixel displacement, the visual similarity of the events, and the like. The detection can be performed by using the related techniques. Further, at operation 1003, the semantic relationship computation block 307, may obtain, based on a result of the detection, the semantic relationship between each of the primary events and the one or more secondary events with respect to a plurality of semantic relationship parameters. As an example, the plurality of semantic relationship parameters may include, but are not limited to, proximity of the identified one or more objects and the one or more faces with respect to the camera, the gaze angles of the one or more users, the pixel displacement in the primary region and the one or more secondary regions, the visual similarity in the primary event, the visual similarity in the one or more secondary regions and the like. The semantic relationship computation block 307 may output an events semantic relationship matrix 1005 along with its relationship depicted in block 1007. In an example, the semantic relationship between each of the primary events and the one or more secondary events may be stored for sentence format as shown in block 1007.

According to some embodiments, when no context information is available (null context) that is when the outputs of the extractor 303 and the event ranker 305 are not performed. In such cases, the semantic relationship computation block 307 may evaluate the semantic relationship directly and the event node with most inward connections is considered to be the primary event.

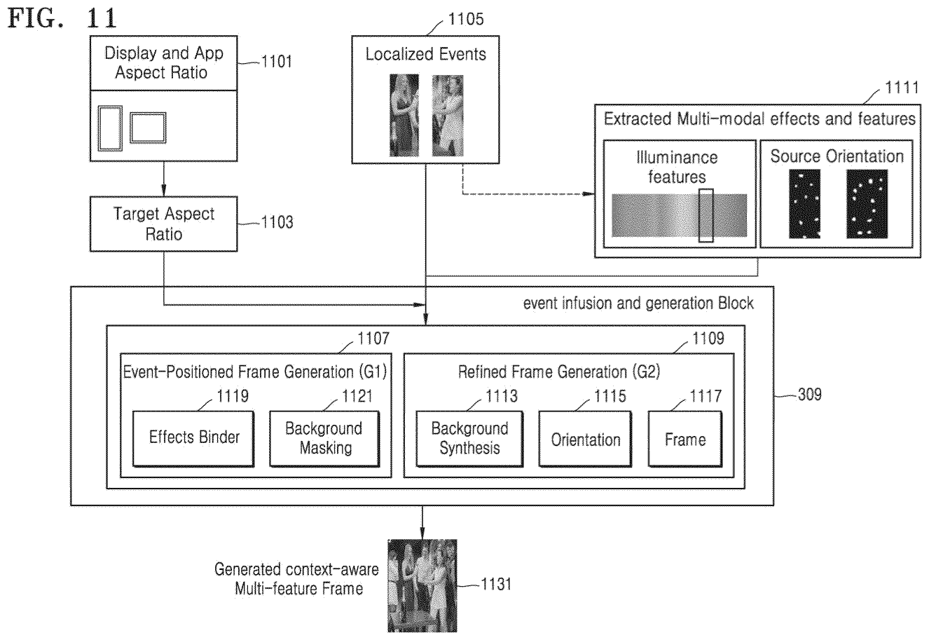

FIG. 11 illustrates a detailed operation generation of frames with a target aspect ratio, according to an embodiment of the disclosure. Referring back to FIG. 4, at operation 405, the event infusion and generation block 309 may determine an aspect ratio i.e. a target aspect ratio 1103 in which the video is to be displayed on at least one of the devices or the one or more applications. To determine the target aspect ratio in which the video is to be displayed on at least one of the devices or the one or more applications, the event infusion and generation block 309 may obtain a context of the one or more applications and display properties of a display on with the video is to be displayed. For example, the context of the one or more applications can be posts, reels, stories, and the like. The context of the one or more applications can be obtained from system information provided by the system. Further, the display properties of the display on which the video may be to be displayed can be, for example, a physical configuration of the displays. Further, the display properties can be obtained from system information provided by the system.

In an embodiment, the event infusion and generation block 309 may categorize the aspect ratio and determine the target aspect ratio based on the context of the one or more applications and display properties of a display. Further, the event infusion and generation block 309, at operation 407, may predict the positions of the primary event and the one or more secondary events according to the semantic relationship and the determined first aspect ratio by using a pre-learned Artificial Intelligence (AI) model implemented in the event infusion and generation block 309. The pre-learned AI model is depicted as an event-positioned frame generation (G1) 1107. In an embodiment, the event-positioned frame generation (G1) 1107 may generate aspect ratio aware event-located frames by binding effects (e.g. illuminance, lightening, depth, audio direction, etc.) and utilizing events semantic relationship for generation. For each event, LSTM cell's feature map may be added to corresponding event relationship embedding and effects embedding which helps model to learn event wise importance, effects, positioning and priority with respect to other events.

An effects binder 1119 of the event-positioned frame generation (G1) 1107 may blend the prioritized events into the generated frame(s) of the desired aspect ratio (target ratio). Effects, such as illuminance, lightening, depth, audio direction, may be extracted from primary events which is fed into layer of the CNN to generate embedding and then it is reshaped to fed into Conv-LSTM cell. Effects help in improving image aesthetics and quality.

According to an embodiment, the background masking block 1121 may perform background masking of the image background so that only primary and secondary events features can be extracted.

According to an embodiment, the event-positioned frame generation (G1) 1107 may predict the positions of the primary event and the one or more secondary events. Further, at operation 409, event infusion and generation block 309 may generate frames matching the determined first aspect ratio and having the predicted positions of the primary event and one or more secondary events for displaying the video with the obtained frames with the determined first aspect ratio. To obtain the frames matching with the target aspect ratio and having the predicted positions of the primary event and one or more secondary events, the infusion and generation block 309 may obtain the background features, by performing background synthesis block 1113, of the primary event and each of the one or more secondary events based on the semantic relationship and the assigned second priority. Further, the infusion and generation block 309 may determine a plurality of aesthetic effects for the primary event and each of the one or more secondary events based on the background features and an event score from the semantic relationship. In an example, at block 1111, the infusion and generation block 309 may extract the multi-modal effects and features like illuminance features, source orientation, lightening, contrast, depth, audio direction, pose changes and the like. Further, the infusion and generation block 309 may generate frames matching with the target aspect ratio and having the predicted positions of the primary event and one or more secondary events along with the determined plurality of aesthetic effects. In an embodiment, the generated frames may be further refined at a refined frame generation (G2) 1109 where a background synthesis block 1113 is performed by a background synthesizer of the event infusion and generation block 309. In an embodiment, the background synthesis block 1113 may be used to apply background features in the generated frames, and then the orientation 1115 and quality of the frames may be refined and improvised.

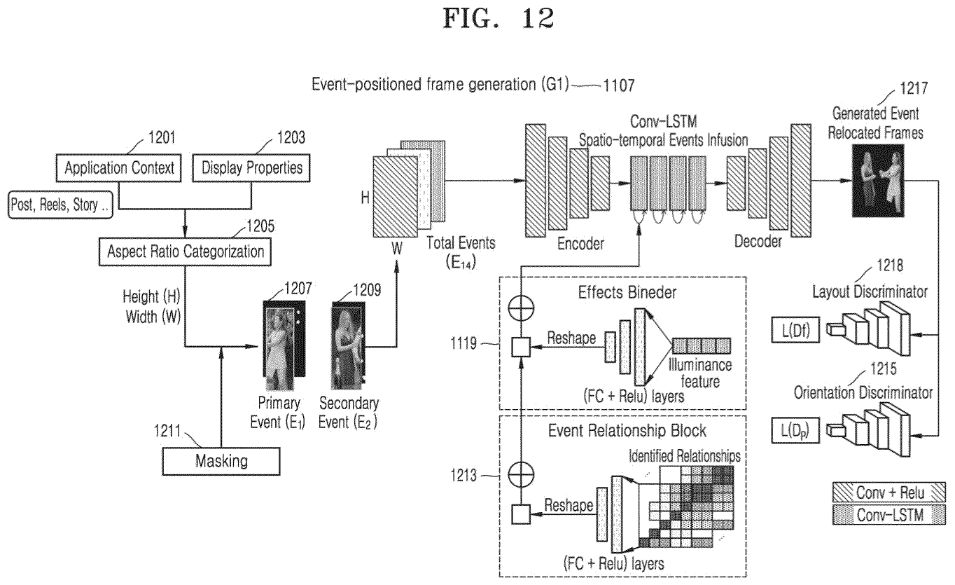

FIG. 12 illustrates an event-positioned frame generation (G1) 1107, according to an embodiment of the disclosure. In an embodiment, FIG. 12 illustrates, the event-positioned frame generation (G1) 1107 depicted in FIG. 11 in detail. The implemented method remain the same therefore, for the sake brevity the details explanation is omitted here. The event-positioned frame generation (G1) 1107 may generate the aspect ratio aware event located frames by applying binding effects (illuminance, lightening, depth, audio direction, etc.) and utilizing events semantic relationship. For each event, LSTM cell's feature map may be added to corresponding event relationship embedding and effects embedding which helps model to learn event wise importance, effects, positioning and priority with respect to other events.

In an embodiment, at block 1201, 1203 the application context and the display properties are obtained. Then based on the application context and the display properties, the aspect ratio may be categorized at block 1205. The aspect ratio is further utilized for aspect ratio aware event located frames i.e. the primary events 1207 and the secondary events 1209 after masking 1211. The events are then fed into Conv-LSTM block. The Conv-LSTM block further takes input from the effects binder 1119 and the event relationship block 1213 to generate event relocated frames 1217. In an example, the event relationship block 1213 may understand relationship between each pair of events. The semantic relationship matrix is calculated for all events. The primary and secondary events are selected based on relation scores and fully connected layers are applied to generated relationship embedding's for each events.

The layout discriminator 1218 may discriminate overall quality of the image with respect to real image and send the feedback to generator to improve the overall image quality using binary cross entropy loss function. Further, the orientation discriminator 1215 may discriminate the orientation of primary and secondary events with respect to the given aspect ratio and send the feedback to generator to improve the orientation quality using binary cross entropy loss. Accordingly, for each event, LSTM cell's feature map is added to corresponding event relationship embedding and effects embedding which helps model to learn event wise importance, effects, positioning and priority with respect to other events.

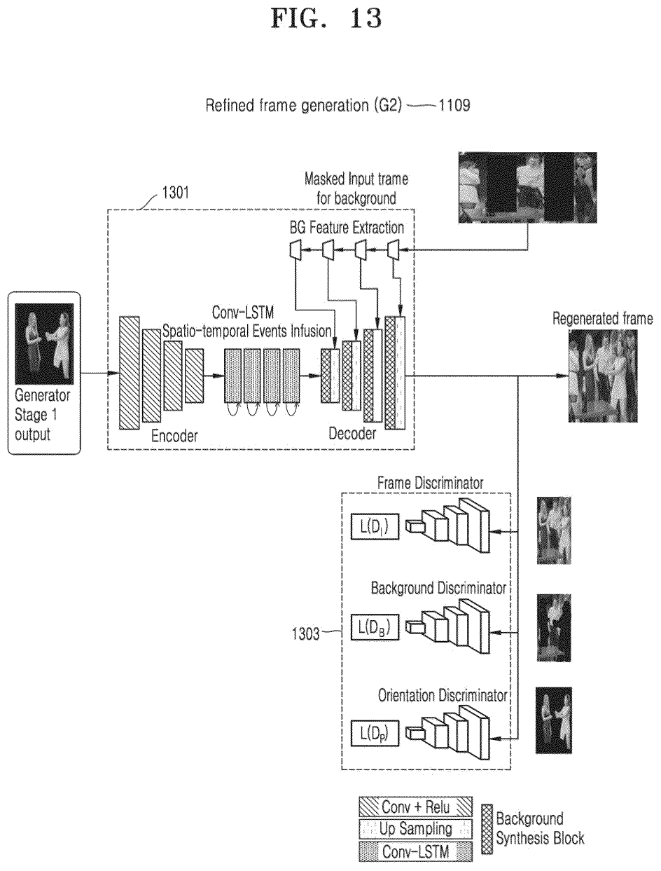

FIG. 13 illustrates a refined frame generation (G2) 1109 according to an embodiment of the disclosure. According to an embodiment, the generated output from event-positioned frame generation (G1) 1107 may be utilized to further refine the image quality by applying background feature extraction which extracts background features present in the input frame using fully connected network shown at blocks 1301 and 1303. The block 1303 may form the part of the background synthesis block 1113 of FIG. 11. Frame discriminator is used to enhance the overall generated frame quality, and background discriminator utilizes masked input frame for background regeneration, and orientation discriminator is used to enhance orientation of the frames. Blocks 1301 and 1303 represents the implemented CNN block and discriminator networks for fusing extracted background features and improving image generation quality using multiple discriminators respectively.

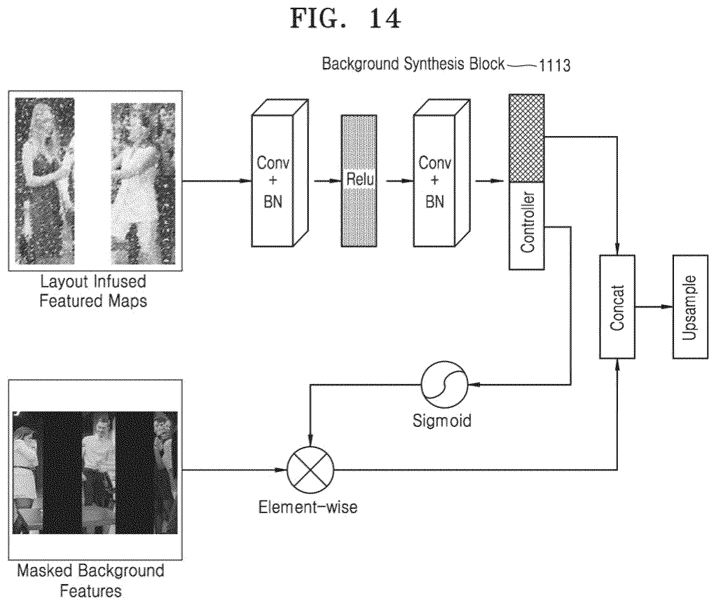

FIG. 14 illustrates a background synthesis block 1113 according to an embodiment of the disclosure. FIG. 14 shown a detail implementation of the CNN model in the background synthesis block 1113 of FIG. 11. As explained above, the background synthesis block 1113 may be used to apply background features in the generated images. In an embodiment, the background synthesis block 1113 may use input from layout infused feature map (primary and secondary events infused in given aspect ratio based on the semantic relationship) and masked background (input frame which is masked to get background only features) to determine amount of background information retained for the generated image which also prevents the background and the foreground from overlapping each other.

In an embodiment, for the event-positioned frame generation (G1) 1107, the adversarial loss is a total binary cross entropy loss for the final generated image (I_{G}), generated masked background (B_{G}) and generated individual objects (I_{Gi}) given multiple conditional inputs given by the equation (a).

$$L ( G {1}_{adv} ) = {L}_{b c e} ( D f ( G 1 ( {I}_{f} ) ) , 1 ) + {L}_{b c e} ( DP ( G 1 ( {I}_{f} ) ) , 1 ) ) \qquad ( a )$$

For the refined frame generation (G2) 1109, the adversarial loss is a total binary cross entropy loss for the final generated image (IG), generated masked background (BG), and generated individual objects (IGi) given multiple conditional inputs given by the equation (b).

$$L ( G {2}_{a d v} ) = {L}_{b c e} ( DI ( G 2 ( {I}_{G} ) ) , 1 ) + {L}_{b c e} ( {D}_{B} ( G 2 ( {I}_{G} ) ) , 1 ) + {L}_{b c e} ( D P ( G 2 ( {I}_{G} ) ) , 1 ) \qquad ( b )$$

The total Generator (G2) loss is the sum of adversarial loss and weighted sum of L1 loss for final images and masked background Orientation mask MB is multiplied to L1 loss such that the background is given more weight than the foreground objects and given by equation (c).

$$L ( {G}_{overall} ) = L ( G {1}_{adv} ) + L ( G {2}_{a d v} ) + λ 1 {‖ {I}_{R} - G 2 ( {I}_{G} ) ‖}_{1} + λ 2 {‖ ( G 2 ( {I}_{G} ) - {B}_{R} ) ⊙ ( 1 + {M}_{B} ) ‖}_{1} \qquad ( c )$$

The layout discriminator loss is the binary cross entropy loss between final real image and final generated image by G2 (stage 2) and given by equation (d).

$$L ( D f ) = {L}_{b c e} ( {D}_{f} ( {I}_{R} ) , 1 ) + L b c e ( D f ( G 1 ( {I}_{G} ) ) , 0 ) \qquad ( d )$$

Further, the frame or overall image discriminator loss are the binary cross entropy loss between final real image and final generated image by G2 (stage 2) and is given by equation (e).

$$L ( DI ) = {L}_{b c e} ( {D}_{I} ( {I}_{R} ) , 1 ) + L b c e ( DI ( G 2 ( {I}_{G} ) ) , 0 ) \qquad ( e )$$

Further, the background discriminator loss is the binary cross entropy loss between real masked background (B_{R}) and generated masked background (B_{G}) given conditional input background B and is given by equation (f).

$$L ( D B ) = {L}_{b c e} ( {D}_{B} ( {I}_{R} ) , 1 ) + L b c e ( D B ( G 2 ( {I}_{G} ) ) , 0 ) \qquad ( f )$$

Further, the orientation discriminator loss is the binary cross entropy loss between the individual real object (IRᵢ) and generated object (IGᵢ) given conditional input localized events (Eᵢ) and is given by equation (g).

$$L ( {D}_{P} ) = {L}_{b c e} ( {D}_{P} ( {I}_{R} ) , 1 ) + L b c e ( D P ( G 2 ( {I}_{G} ) ) , 0 ) \qquad ( g )$$

The explanation of the variables used in the equations (a) to (g) is given in Table 3:

TABLE 3

Where,
G1 = Positioned Frame Generation G1 (stage 1)
G2 = Generator network G2 (stage 2)
I_{R} = Real Input Image
I_{G} = Generated Image
I_{f} = Masked Input frame
M_{B} ″ Background Mask
B_{R} = Real Masked background
G_{adv} = adversarial generative loss
λ1, λ2 = Hyper parameters
= pixel-wise multiplication
Where,
D₁ = Image Discriminator Network
D_{B} = Background Discriminator Network
Dₚ = Orientation Discriminator Network
D_{f} = Layout Discriminator Network
I_{R} = Real Input Image
I_{G} = Generated Image
L_{bce} = Binary cross entropy loss

In an embodiment, the event-positioned frame generation (G1) 1107 and the refined frame generation (G2) 1109 may utilize various Conv-LSTM, frame discriminators, background discriminators, layout discriminators, and orientation discriminators for generating the frames with the targeted aspect ratio. Accordingly, the infusion and generation block 309 may generate the frame 1131 context-aware Multi-feature Frame with the targeted aspect ratio.

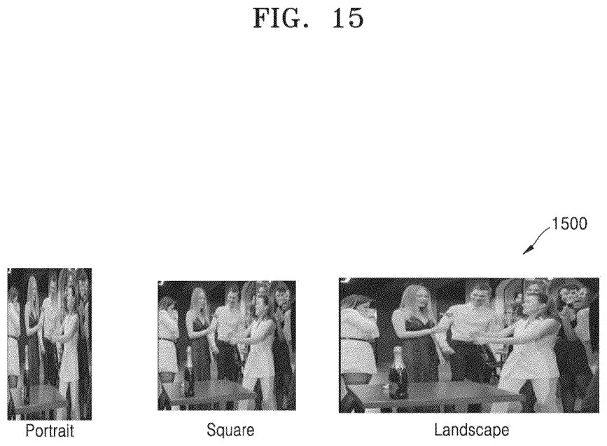

FIG. 15 illustrates an example of the generated frames, according to an embodiment of the disclosure. As can be seen in block 1501 the generated frames can be in portrait, square, or landscape that are generated based on the aspect ratio of the display or applications.

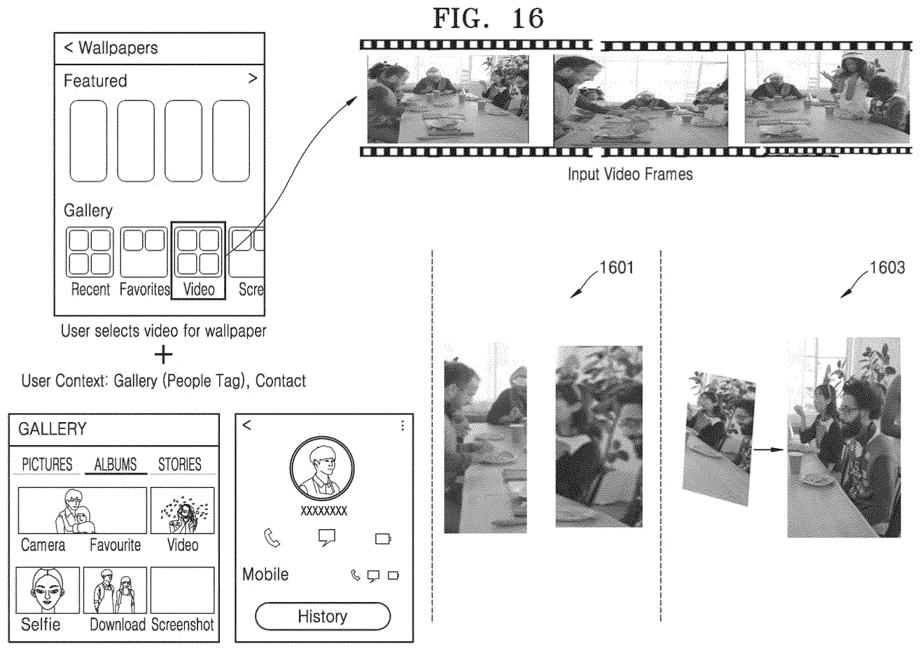

FIG. 16 illustrates an example of the generated frames in comparison to a related method, according to an embodiment of the disclosure. According to an example scenario, the user may select a video for wallpaper. Further, the user context is obtained from a gallery, people tagged in, or the contact information. Thus, according to a related solution, a random cropped video is shown as wallpaper as depicted in block 1601. Further, based on the disclosed methodology, the wallpaper shows multiple objects that are dynamically adjusted to maintain video context based on the display as depicted in block 1603.

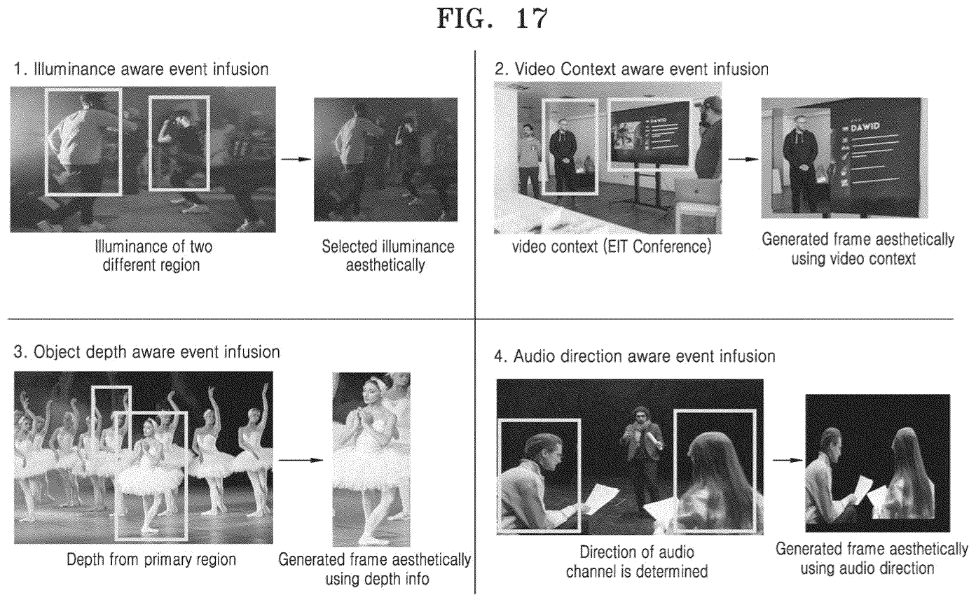

FIG. 17 illustrates an example of the generated frames, according to an embodiment of the disclosure. According to an example scenario 1, an illuminance-aware event infusion is disclosed where the selected frames are aesthetically illuminated. Further scenario 2, video context-aware event infusion is shown where the video context and key region are aesthetically regenerated. Further, in scenarios 3 and scenario 4 object depth-aware event infusion and audio direction-aware event infusion where the depth of the primary region and direction of the audio are determined respectively for aesthetically regenerating the frames.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

According to an embodiment of the disclosure, the aspect ratio based method may include identifying the primary event and the one or more secondary events, based on an analysis of at least one of an audio of the video frames, the video frames, and a plurality of multi-modal contextual inputs.

According to an embodiment of the disclosure, the aspect ratio based method may include obtaining the video frames and the plurality of multi-modal contextual inputs from at least one of a user input or one or more applications in the electronic device. According to an embodiment of the disclosure, the aspect ratio based method may include performing the analysis of the video frames. According to an embodiment of the disclosure, the analysis of the video frame may comprise determining a depth map based on a RedGreenBlue-Depth (RGBD) data or a RedGreenBlue (RGB) data in the obtained video frames. According to an embodiment of the disclosure, the analysis of the video frame may comprise estimating a depth-aware optical flow comprising one or more flow points respective of each of the video frames, based on the key corners and the depth map. According to an embodiment of the disclosure, the analysis of the video frame may comprise classifying similar depth-aware optical flows, using curve matching techniques, into one or more categories, wherein the one or more categories respectively correspond to one or more flow clusters. According to an embodiment of the disclosure, the analysis of the video frame may comprise determining a first category among the one or more categories having a highest cardinality, wherein the highest cardinality corresponds to a highest number of optical flows in a cluster among the one or more clusters. According to an embodiment of the disclosure, the analysis of the video frame may comprise obtaining one or more convex hull points, encompassing the one or more flow points in each of the one or more clusters and the first category. According to an embodiment of the disclosure, the analysis of the video frame may comprise determining one or more bounding boxes enclosing each of the obtained one or more convex hull points, wherein the one or more bounding boxes comprise the primary region and the one or more secondary regions.

According to an embodiment of the disclosure, the depth-aware optical flow of each of the video frames may comprise motion vectors and flow between the video frames. According to an embodiment of the disclosure, the depth-aware optical flow may comprise one or more flow points respective of each of the video frames. According to an embodiment of the disclosure, the depth-aware optical flow between the video frames may represent a movement of one or more flow points along with the video frames. According to an embodiment of the disclosure, the one or more bounding boxes may indicate localized events.

According to an embodiment of the disclosure, the aspect ratio based method may include performing the analysis of the audio and the plurality of multi-modal contextual inputs. According to an embodiment of the disclosure, the analysis of the audio and the plurality of multi-modal contextual inputs may comprise obtaining a plurality of features from the plurality of multi-modal contextual inputs and audio features of the audio of the video frames. According to an embodiment of the disclosure, the analysis of the audio and the plurality of multi-modal contextual inputs may comprise determining contextual features for each of the plurality of multi-modal contextual inputs based on the extracted plurality of features, wherein the primary event in the primary region and the one or more secondary events in the one or more secondary regions are identified based on determined contextual features.

According to an embodiment of the disclosure, the plurality of multi-modal contextual inputs may comprise at least one of incoming messages, profile pictures of one or more users, future frames in the video frames, or an activity associated with the one or more users. According to an embodiment of the disclosure, the audio features in the video frames may comprise voice samples of the one or more users in the video frames. According to an embodiment of the disclosure, the plurality of features may comprise at least one of word embeddings in the incoming messages, image features in the profile pictures of the one or more users, timestamp features in the voice samples, retrospective features in the future frames, or action features in the activity associated with the one or more users.

According to an embodiment of the disclosure, the aspect ratio based method may include encoding the primary event, the one or more secondary events, and the contextual features. According to an embodiment of the disclosure, the aspect ratio based method may include determining a plurality of event vectors and a plurality of context vectors for the primary event and each of the one or more secondary events based on the encoded primary event, the encoded one or more secondary events, and the encoded contextual features. According to an embodiment of the disclosure, the aspect ratio based method may include computing similarity between each of the plurality of context vectors and the event vectors. According to an embodiment of the disclosure, the aspect ratio based method may include determining a similarity score for each of the context vectors and the event vectors based on a result of computation. According to an embodiment of the disclosure, the aspect ratio based method may include determining a first priority for the each of the event vectors based on at least a contextual contrastive loss, similarity loss, dissimilarity loss, and the determined similarity score. According to an embodiment of the disclosure, the aspect ratio based method may include assigning the first priority and a second priority to the primary event and each of the one or more secondary events based on the determined contextual contrastive loss, similarity loss, dissimilarity loss, and similarity scores.

According to an embodiment of the disclosure, obtaining the semantic relationship between the identified primary event and the one or more secondary events may comprise identifying at least one of one or more objects, one or more faces, an orientation of a head of one or more users, gaze angles of the one or more users in the primary event in the primary region and in the one or more secondary events in the one or more secondary regions based on a performance of the analysis of the video. According to an embodiment of the disclosure, obtaining the semantic relationship between the identified primary event and the one or more secondary events may comprise obtaining, based on a result of the detection, the semantic relationship between each of the primary event and the one or more secondary events with respect to a plurality of semantic relationships parameters, wherein the plurality of semantic relationship parameters comprise proximity of the identified one or more objects and the one or more faces with respect to a camera, the gaze angles of the one or more users, a pixel displacement in the primary region and the one or more secondary regions, a visual similarity in the primary event, the visual similarity in the one or more secondary regions.

According to an embodiment of the disclosure, the first aspect ratio may be determined based on a second aspect ratio of at least one of the display of the device for displaying the video or the one or more applications.

According to an embodiment of the disclosure, obtaining the frames may comprise obtaining background features of the primary event and each of the one or more secondary events based on the semantic relationship and the assigned second priority. According to an embodiment of the disclosure, obtaining the frames may comprise determining a plurality of aesthetic effects for the primary event and each of the one or more secondary events based on the background features and an event score from the semantic relationship. According to an embodiment of the disclosure, obtaining the frames may comprise obtaining frames matching with the determined first aspect ratio and having the predicted positions of the primary event and the one or more secondary events along with the determined plurality of aesthetic effects.

According to an embodiment of the disclosure, the plurality of aesthetic effects may comprise at least one of a depth effect, a pose change effect, a luminance effect, a lightning effect, and an audio effect with respect to the primary region.

According to an embodiment of the disclosure, the primary event and the one or more secondary events may be identified based on an analysis of at least one of an audio of the video frames, the video frames and a plurality of multi-modal contextual inputs.

According to an embodiment of the disclosure, the one or more processors are configured to obtain video frames and the plurality of multi-modal contextual inputs from at least one of a user input or one or more application in a device. According to an embodiment of the disclosure, the one or more processors are configured to perform the analysis of the video frame. According to an embodiment of the disclosure, the analysis of the video frame may comprise determine a depth map based on a RedGreenBlue-Depth (RGBD) data or a RedGreenBlue (RGB) data in the obtained video frames. According to an embodiment of the disclosure, the analysis of the video frame may comprise identify key corners for each of the video frames based on the determined RGBD data or the RGB data. According to an embodiment of the disclosure, the analysis of the video frame may comprise estimate a depth-aware optical flow including one or more flow points respective of each of the video frames based on the key corners and the depth map. According to an embodiment of the disclosure, the analysis of the video frame may comprise classify similar depth-aware optical flows, using curve matching techniques, into one or more categories, wherein the one or more categories corresponds to one or more flow clusters. According to an embodiment of the disclosure, the analysis of the video frame may comprise determine a first category among the one or more categories having a highest cardinality, wherein the highest cardinality refers to a highest number of optical flows in a cluster among the one or more clusters. According to an embodiment of the disclosure, the analysis of the video frame may comprise obtain one or more convex hull points, encompassing the one or more flow points in each of the one or more clusters and the first category. According to an embodiment of the disclosure, the analysis of the video frame may comprise determine one or more bounding boxes enclosing each of the obtained one or more convex hull points, wherein the one or more bounding boxes comprise the primary region and the one or more secondary regions.

According to an embodiment of the disclosure, the depth aware optical flow of each of the video frames may comprise motion vectors and flow between the video frames. According to an embodiment of the disclosure, the depth aware optical flow may comprise one or more flow points respective of each of the video frames. According to an embodiment of the disclosure, the depth aware optical flow between the video frames may represent a movement of one of more flow points along with the video frames. According to an embodiment of the disclosure, the one or more bounding box may indicate localized events.

According to an embodiment of the disclosure, the one or more processors may be configured to perform the analysis of the audio and the plurality of multi-modal contextual inputs. According to an embodiment of the disclosure, the analysis of the audio and the plurality of multi-modal contextual inputs may comprise obtain a plurality of features from the plurality of multi-modal contextual inputs and audio features of the audio of the video frames. According to an embodiment of the disclosure, the analysis of the audio and the plurality of multi-modal contextual inputs may comprise determine contextual features for each of the plurality of multi-modal contextual inputs based on the extracted plurality of features, wherein the primary event in the primary region and the one or more secondary events in the one or more secondary regions are identified based on determined contextual features.

According to an embodiment of the disclosure, the plurality of multi-modal contextual inputs may comprise at least one of incoming messages, profile pictures of one or more users, future frames in the video frames, or an activity associated with the one or more users. According to an embodiment of the disclosure, the audio features in the video frames may comprise voice samples of the one or more users in the video frames. According to an embodiment of the disclosure, the plurality of features may comprise at least one of word embeddings in the incoming messages, image features in the profile pictures of the one or more users, timestamp features in the voice samples, retrospective features in the future frames, or action features in the activity associated with the one or more users.

According to an embodiment of the disclosure, the one or more processors may be configured to encode the primary event, the one or more secondary events, and the contextual features. According to an embodiment of the disclosure, the one or more processors may be configured to determine a plurality of event vectors and a plurality of context vectors for the primary event and each of the one or more secondary events based on the encoded primary event, the encoded one or more secondary events, and the encoded contextual features. According to an embodiment of the disclosure, the one or more processors may be configured to compute similarity between each of the plurality of context vectors and the event vectors. According to an embodiment of the disclosure, the one or more processors may be configured to determine a similarity score for each of the context vectors and event vectors based on a result of computation. According to an embodiment of the disclosure, the one or more processors may be configured to determine a first priority for the each of the event vectors based on at least a contextual contrastive loss, similarity loss, dissimilarity loss, and the determined similarity score. According to an embodiment of the disclosure, the one or more processors may be configured to assign the first priority and a second priority to the primary event and each of the one or more secondary events based on the determined contextual contrastive loss, similarity loss, dissimilarity loss, and similarity scores.

According to an embodiment of the disclosure, to obtain the semantic relationship between the identified primary event and the one or more secondary events, the one or more processors may be configured to identify at least one of one or more objects, one or more faces, orientation of a head of one or more users, gaze angles of the one or more users in the primary event in the primary region and in the one or more secondary events in the one or more secondary regions based on a performance of the analysis of the video. According to an embodiment of the disclosure, to obtain the semantic relationship between the identified primary event and the one or more secondary events, the one or more processors may be configured to obtain, based on a result of the detection, the semantic relationship between each of the primary event and the one or more secondary events with respect to a plurality of semantic relationships parameters wherein the plurality of semantic relationship parameters comprise proximity of the identified one or more objects and the one or more faces with respect to a camera, the gaze angles of the one or more users, a pixel displacement in the primary region and the one or more secondary regions, a visual similarity in the primary event, the visual similarity in the one or more secondary regions. According to an embodiment of the disclosure, to obtain the frames, the one or more processors may be configured to obtain background features of the primary event and each of the one or more secondary events based on the semantic relationship and the assigned second priority. According to an embodiment of the disclosure, to obtain the frames, the one or more processors may be configured to determine a plurality of aesthetic effects for the primary event and each of the one or more secondary events based on the background features and an event score from the semantic relationship. According to an embodiment of the disclosure, to obtain the frames, the one or more processors may be configured to obtain frames matching with the determined first aspect ratio and having the predicted positions of the primary event and the one or more secondary events along with the determined plurality of aesthetic effects.

According to an embodiment of the disclosure, the plurality of aesthetic effects may comprise at least one of a depth effect, a pose change effect, a luminance effect, a lightning effect, and an audio effect with respect to the primary region.

According to an embodiment of the disclosure, above devices and methods may overcome various aforesaid issues.

What is claimed is:

1. An aspect ratio based method for displaying a video, the aspect ratio based method comprising:
identifying a primary event in a primary region and one or more secondary events in one or more secondary regions, within each of video frames of a video, based on an analysis of the video frames;
obtaining a semantic relationship between the identified primary event and the one or more secondary events;
determining a first aspect ratio in which the video is displayed on at least one of an electronic device or one or more applications;
predicting, using an Artificial Intelligence (AI) model, positions of the primary event and the one or more secondary events, based on the semantic relationship and the determined first aspect ratio;
obtaining frames matching the determined first aspect ratio and having the predicted positions of the primary event and one or more secondary events; and
displaying the video having the obtained frames and the determined first aspect ratio.

2. The aspect ratio based method of claim 1, further comprising identifying the primary event and the one or more secondary events, based on an analysis of at least one of an audio of the video frames, the video frames, and a plurality of multi-modal contextual inputs.

3. The aspect ratio based method of claim 2, further comprising:
obtaining the video frames and the plurality of multi-modal contextual inputs from at least one of a user input or one or more applications in the electronic device; and
performing the analysis of the video frames,
wherein the analysis of the video frame comprises:
determining a depth map based on a RedGreenBlue-Depth (RGBD) data or a RedGreenBlue (RGB) data in the obtained video frames;
identifying key corners for each of the video frames based on the determined RGBD data or the RGB data;
estimating a depth-aware optical flow comprising one or more flow points respective of each of the video frames, based on the key corners and the depth map;
classifying similar depth-aware optical flows, using curve matching techniques, into one or more categories, wherein the one or more categories respectively correspond to one or more flow clusters;
determining a first category among the one or more categories having a highest cardinality, wherein the highest cardinality corresponds to a highest number of optical flows in a cluster among the one or more clusters;
obtaining one or more convex hull points, encompassing the one or more flow points in each of the one or more clusters and the first category; and
determining one or more bounding boxes enclosing each of the obtained one or more convex hull points, wherein the one or more bounding boxes comprise the primary region and the one or more secondary regions.

4. The aspect ratio based method of claim 3, wherein the depth-aware optical flow of each of the video frames comprises motion vectors and flow between the video frames,
wherein the depth-aware optical flow comprises one or more flow points respective of each of the video frames,
wherein the depth-aware optical flow between the video frames represents a movement of one or more flow points along with the video frames, and
wherein the one or more bounding boxes indicate localized events.

5. The aspect ratio based method of claim 3, further comprising:
performing the analysis of the audio and the plurality of multi-modal contextual inputs, wherein the analysis of the audio and the plurality of multi-modal contextual inputs comprises:
obtaining a plurality of features from the plurality of multi-modal contextual inputs and audio features of the audio of the video frames; and
determining contextual features for each of the plurality of multi-modal contextual inputs based on the extracted plurality of features, wherein the primary event in the primary region and the one or more secondary events in the one or more secondary regions are identified based on determined contextual features.

6. The aspect ratio based method of claim 5, wherein the plurality of multi-modal contextual inputs comprise at least one of incoming messages, profile pictures of one or more users, future frames in the video frames, or an activity associated with the one or more users, wherein the audio features in the video frames comprise voice samples of the one or more users in the video frames, and
wherein the plurality of features comprise at least one of word embeddings in the incoming messages, image features in the profile pictures of the one or more users, timestamp features in the voice samples, retrospective features in the future frames, or action features in the activity associated with the one or more users.

7. The aspect ratio based method of claim 5, further comprising:
encoding the primary event, the one or more secondary events, and the contextual features;
determining a plurality of event vectors and a plurality of context vectors for the primary event and each of the one or more secondary events based on the encoded primary event, the encoded one or more secondary events, and the encoded contextual features;
computing similarity between each of the plurality of context vectors and the event vectors;
determining a similarity score for each of the context vectors and the event vectors based on a result of computation;
determining a first priority for the each of the event vectors based on at least a contextual contrastive loss, similarity loss, dissimilarity loss, and the determined similarity score; and
assigning the first priority and a second priority to the primary event and each of the one or more secondary events based on the determined contextual contrastive loss, similarity loss, dissimilarity loss, and similarity scores.

8. The aspect ratio based method of claim 1 wherein obtaining the semantic relationship between the identified primary event and the one or more secondary events comprises:
identifying at least one of one or more objects, one or more faces, an orientation of a head of one or more users, gaze angles of the one or more users in the primary event in the primary region and in the one or more secondary events in the one or more secondary regions based on a performance of the analysis of the video; and
obtaining, based on a result of the detection, the semantic relationship between each of the primary event and the one or more secondary events with respect to a plurality of semantic relationships parameters,
wherein the plurality of semantic relationship parameters comprise proximity of the identified one or more objects and the one or more faces with respect to a camera, the gaze angles of the one or more users, a pixel displacement in the primary region and the one or more secondary regions, a visual similarity in the primary event, the visual similarity in the one or more secondary regions.

9. The aspect ratio based method of claim 1, wherein the first aspect ratio is determined based on a second aspect ratio of at least one of the display of the device for displaying the video or the one or more applications.

10. The aspect ratio based method of claim 1, wherein obtaining the frames comprises:
obtaining background features of the primary event and each of the one or more secondary events based on the semantic relationship and the assigned second priority;
determining a plurality of aesthetic effects for the primary event and each of the one or more secondary events based on the background features and an event score from the semantic relationship; and
obtaining frames matching with the determined first aspect ratio and having the predicted positions of the primary event and the one or more secondary events along with the determined plurality of aesthetic effects.

11. The aspect ratio based method of claim 10, wherein the plurality of aesthetic effects comprise at least one of a depth effect, a pose change effect, a luminance effect, a lightning effect, and an audio effect with respect to the primary region.

12. An aspect ratio based an electronic device for displaying a video, the aspect ratio based the electronic device comprising one or more processors configured to:
identify a primary event in a primary region and one or more secondary events in one or more secondary regions within each video frames of a video based on an analysis of the video frames;
obtain a semantic relationship between the identified primary event and the one or more secondary events;
determine a first aspect ratio in which the video is to be displayed on at least one of an electronic device or one or more applications;
predict, using an Artificial Intelligence (AI) model, positions of the primary event and the one or more secondary events according to the semantic relationship and the determined first aspect ratio;
obtain frames matching the determined first aspect ratio and having the predicted positions of the primary event and one or more secondary events; and
displaying the video with the obtained frames with the determined first aspect ratio.

13. The aspect ratio based the electronic device of claim 12, wherein the primary event and the one or more secondary events are identified based on an analysis of at least one of an audio of the video frames, the video frames and a plurality of multi-modal contextual inputs.

14. The aspect ratio based the electronic device of claim 13, wherein the one or more processors are configured to:
obtain video frames and the plurality of multi-modal contextual inputs from at least one of a user input or one or more application in a device; and
perform the analysis of the video frame,
wherein the analysis of the video frame comprises:
determine a depth map based on a RedGreenBlue-Depth (RGBD) data or a RedGreenBlue (RGB) data in the obtained video frames;
identify key corners for each of the video frames based on the determined RGBD data or the RGB data;
estimate a depth-aware optical flow including one or more flow points respective of each of the video frames based on the key corners and the depth map;
classify similar depth-aware optical flows, using curve matching techniques, into one or more categories, wherein the one or more categories corresponds to one or more flow clusters;
determine a first category among the one or more categories having a highest cardinality, wherein the highest cardinality refers to a highest number of optical flows in a cluster among the one or more clusters;
obtain one or more convex hull points, encompassing the one or more flow points in each of the one or more clusters and the first category; and
determine one or more bounding boxes enclosing each of the obtained one or more convex hull points, wherein the one or more bounding boxes comprise the primary region and the one or more secondary regions.

15. The aspect ratio based the electronic device of claim 14, wherein the one or more processors are configured to:
perform the analysis of the audio and the plurality of multi-modal contextual inputs, wherein the analysis of the audio and the plurality of multi-modal contextual inputs comprises:
obtain a plurality of features from the plurality of multi-modal contextual inputs and audio features of the audio of the video frames; and
determine contextual features for each of the plurality of multi-modal contextual inputs based on the extracted plurality of features, wherein the primary event in the primary region and the one or more secondary events in the one or more secondary regions are identified based on determined contextual features.

16. The aspect ratio based the electronic device of claim 12, wherein to obtain the semantic relationship between the identified primary event and the one or more secondary events, the one or more processors are configured to:
identify at least one of one or more objects, one or more faces, orientation of a head of one or more users, gaze angles of the one or more users in the primary event in the primary region and in the one or more secondary events in the one or more secondary regions based on a performance of the analysis of the video; and
obtain, based on a result of the detection, the semantic relationship between each of the primary event and the one or more secondary events with respect to a plurality of semantic relationships parameters,
wherein the plurality of semantic relationship parameters comprise proximity of the identified one or more objects and the one or more faces with respect to a camera, the gaze angles of the one or more users, a pixel displacement in the primary region and the one or more secondary regions, a visual similarity in the primary event, the visual similarity in the one or more secondary regions.

17. The aspect ratio based the electronic device of claim 12, wherein the first aspect ratio is determined based on a second aspect ratio of at least one of the display of the device for displaying the video or the one or more applications.

18. The aspect ratio based the electronic device of claim 12, wherein to obtain the frames, the one or more processors are configured to:
obtain background features of the primary event and each of the one or more secondary events based on the semantic relationship and the assigned second priority;
determine a plurality of aesthetic effects for the primary event and each of the one or more secondary events based on the background features and an event score from the semantic relationship; and
obtain frames matching with the determined first aspect ratio and having the predicted positions of the primary event and the one or more secondary events along with the determined plurality of aesthetic effects.

19. The aspect ratio based the electronic device of claim 12, wherein the plurality of aesthetic effects comprise at least one of a depth effect, a pose change effect, a luminance effect, a lightning effect, and an audio effect with respect to the primary region.

20. A non-transitory computer-readable storage medium storing instructions that, when executed by at least one processor, cause the at least one processor to:
identify a primary event in a primary region and one or more secondary events in one or more secondary regions, within each of video frames of a video, based on an analysis of the video frames;
obtain a semantic relationship between the identified primary event and the one or more secondary events;
determine a first aspect ratio in which the video is displayed on at least one of an electronic device or one or more applications;
predict, using an Artificial Intelligence (AI) model, positions of the primary event and the one or more secondary events, based on the semantic relationship and the determined first aspect ratio;
obtain frames matching the determined first aspect ratio and having the predicted positions of the primary event and one or more secondary events; and
display the video having the obtained frames and the determined first aspect ratio.
